(19) United States
(12) Patent Application Publication
(10) Pub. No.: US 2007/0001066 A1
(43) Pub. Date: Jan. 4, 2007

(54) Integrated gel keyboard wrist rest

(75) Inventor: David Michael Lane, Sammamish, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/170,098

(22) Filed: Jun. 30, 2005

(51) Int. Cl. B68G 5/00

(52) U.S. Cl. 248/118.1

(57) ABSTRACT

A keyboard including a keyboard housing, a keyboard region including a plurality of keys housed on a top surface of the keyboard region and an integrated gel wrist rest non-removably affixed to an interior surface of the keyboard housing and integrated into the keyboard housing is described. A process for making the keyboard is also described.

### BACKGROUND

Keyboards are fairly common computer hardware devices. Specifically, keyboards are sold for most computers on the market and act as a common input device. Users of computer systems often may be found to use computers and their associated keyboards for extended periods of time. Wrist rests are commonly utilized to alleviate discomfort, pain, and even physical ailments such as “Carpal Tunnel Syndrome” and other work induced disorders.

Wrist rests have been made out of plastic, foam, cloth, and gel. Some users prefer gel wrist rests, however they may be complicated to manufacture. While there are a significant number of keyboards available today, these wrist rests are added by users subsequent to the original manufacturing of the keyboard and often are made by a different manufacturer than the manufacturer of the keyboard without regard to the specific characteristics of the keyboard. These subsequently added wrist rests can negatively impact keyboard characteristics. For example, if the size of the keyboard footprint or the setting of the height of the wrist rest compared to the keys, the user's hand and/or wrist orientation angle while the user is typing is typically caused to be modified negatively, and potential effectiveness of the wrist rest themselves in reducing ailments resulting from use of the accompanying keyboard is significantly limited by the requisite use of a non-integrated keyboard and wrist rest. Thus a keyboard with an improved wrist rest system is desired.

### SUMMARY

To overcome limitations in the prior art described above, and to overcome other limitations that will be apparent upon reading and understanding the present specification, the present invention is directed to an integrated gel keyboard wrist rest and a related process of manufacturing the integrated keyboard with gel wrist rest.

A first aspect of the invention provides an integrated gel keyboard wrist rest with a contiguous structural housing including a wrist rest base member, a plurality of key input regions located on a front surface of the contiguous structural housing, and an integrated wrist rest operably positioned below the key input regions along a bottom border of the contiguous structural housing, wherein the integrated wrist rest includes a gel element and a cover affixing the gel element to the wrist base member portion of the contiguous structural housing. The integrated gel keyboard wrist rest may take on a number of physical configurations including natural style and other ergonomic keyboard designs. The physical characteristics may also vary as the keypad surface and wrist rest surface may have substantially similar angles of orientation. Additionally, the operating components including internal electrical components may be varied so as to provide for numerous functionality, e.g. wireless operation.

A second aspect of the invention provides for a keyboard with integrated gel wrist rest with a keyboard housing including a front and a back, wherein a keyboard region, including a plurality of keys in a plurality of keypad regions, is located on the front surface of the keyboard housing, and an integrated wrist rest member including a base, gel filler, and a cover, wherein the wrist rest member abuts the keyboard region across a boundary along the front surface and the wrist rest element and keyboard region are fully integrated into the keyboard housing such that the keyboard region and the wrist rest form a substantially seamless transition boundary between the wrist rest and the keyboard region within the keyboard housing.

A third aspect of the invention provides a production process for an integrated gel keyboard wrist rest so as to include some of the steps of forming a plastic housing including a keyboard region and a wrist rest base member, attaching a plurality of keypad regions including keys and associated circuitry to the keyboard region of the housing, casting a gel element, placing the gel element on a front surface of the base member, and wrapping a cover over the gel element thereby affixing the gel element to the wrist rest base member so as to form an integrated wrist rest member. Numerous variations and additional steps are also considered to vary the specific physical and use characteristics of the resulting integrated gel keyboard wrist rest.

### DRAWINGS

A more complete understanding of the present invention and the advantages thereof may be acquired by referring to the following description in consideration of the accompanying drawings, in which like reference numbers indicate like features, and wherein:

FIG. 1 illustrates a perspective view of a conventional non-integrated keyboard and wrist rest.

FIG. 2 illustrates a perspective view of another conventional non-integrated keyboard and wrist rest.

FIG. 3 illustrates a perspective view of another conventional non-integrated keyboard and wrist rest.

FIG. 4 illustrates a perspective view of another conventional non-integrated keyboard and wrist rest.

FIG. 5 illustrates a perspective view of an exemplary embodiment of a keyboard and integrated gel wrist rest.

FIG. 6 illustrates a side view if a schematic diagram depicting an exemplary embodiment of an integrated gel wrist rest of the keyboard of FIG. 5.

FIG. 7 illustrates a side view of a schematic diagram of an exemplary embodiment of an integrated gel wrist rest.

FIG. 8 illustrates a perspective view of a schematic diagram of an exemplary embodiment of an integrated gel wrist rest.

FIG. 9 illustrates a block diagram of an exemplary production process for an integrated gel wrist rest.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

Non-integrated gel wrist rests are commonly available for use with keyboards. These wrist rests are typically purchased independent of the keyboard from a number of manufacturers. The wrist rests are typically placed next to the keyboard but are not attached or connected to the keyboard itself. The keyboard and wrist rest typically possess distinct footprints and are easily moved relative to one another.

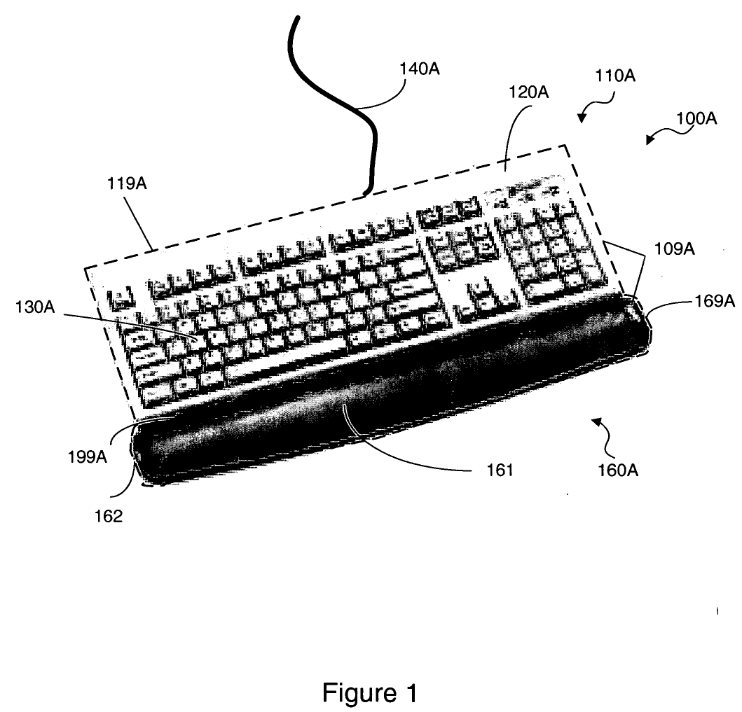

FIGS. 1-4 depict conventional wrist rests as they would be positioned when being used with a keyboard. It is apparent that the wrist rest and keyboards they may be used with are distinct elements each having distinct footprints and borders.

FIG. 1 illustrates a perspective view of a conventional non-integrated keyboard and wrist rest assembly 100A. Non-integrated wrist rest and keyboard assembly 100A has a keyboard 110A, a cable 140A for connecting keyboard 110A to the computer, and a wrist rest 160A. Keyboard 110A has a keyboard frame 120A and keys 130A. Keyboard 110A also defines a footprint 119A, otherwise known as the surface area of the bottom surface.

Non-integrated wrist rest 160A has an inner material 161 and a shell 162. The inner material 161 may be any of a number of softening materials, for example, foam. Wrist rest 160A also has a footprint 169A, i.e. the surface area of the bottom surface of the wrist rest 160A. Between wrist rest 160A and keyboard 11A, there is some physical separation forming a seam 199A. The keyboard and wrist rest assembly 100A, when looked at together in a position such as that in FIG. 1, have a footprint 109A which is the sum of keyboard footprint 119A and wrist rest footprint 169A. As is apparent from FIG. 1, wrist rest footprint 169A constitutes a substantial addition to keyboard footprint 119A.

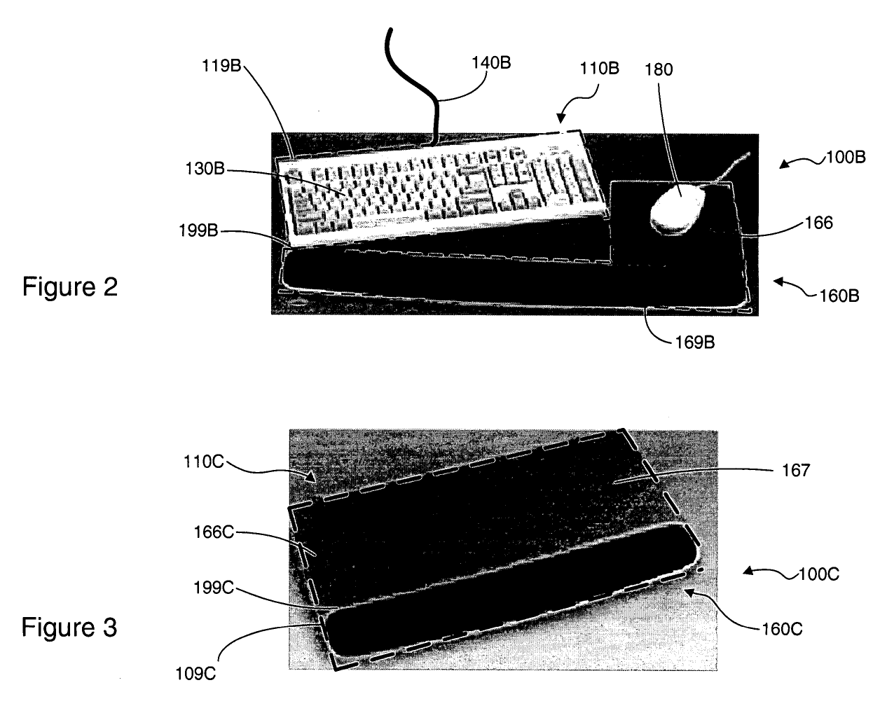

FIG. 2 illustrates a perspective view of another conventional non-integrated keyboard and wrist rest assembly 130B. Keyboard 140B is similar to keyboard 110A and has a keyboard frame 120B and keys 130B. Additionally, cable 140 again serves to connect the keyboard to the remainder of the computer. Wrist rest 160B, similar to wrist rest 160A, has an inner material 161 and a shell 162. Also, seam 199B exists between wrist rest 160B and keyboard 110B. The major distinction between assemblies 100A and 100B is that wrist rest 160B is physically attached to mouse pad 166, with mouse 180 positioned on mouse pad 166B. Hence, keyboard 110B and wrist rest 160B combined with mouse pad 166 defmed footprints 119B and 169B respectively. Once again, when keyboard and wrist rest assembly footprint 109B is considered by adding the footprints 119B and 169B, writ rest footprint 169B adds significantly to keyboard footprint 119B to arrive at keyboard wrist rest assembly 109B.

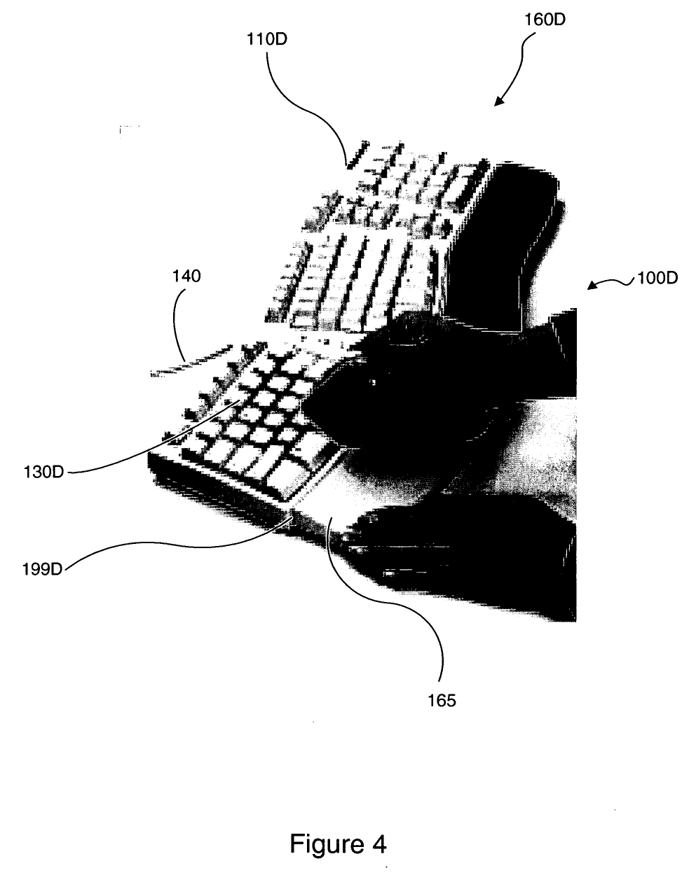

FIG. 3 illustrates a perspective view of yet another conventional non-integrated wrist rest assembly 100C, however the keyboard has been omitted. Wrist rest 160C includes work surface 166C which permits keyboard 110C to be placed on the surface of work surface 166C. When keyboard 110C is placed, the work surface is sufficiently large to permit a mouse 180 to be placed on a portion of work surface 167 so a portion of work surface 167 to serve as a mouse pad. Despite the face that a keyboard may be positioned on work surface 167 of wrist rest 160C, footprint 109C noticeably exceeds in size the footprint of 119C or 169C.

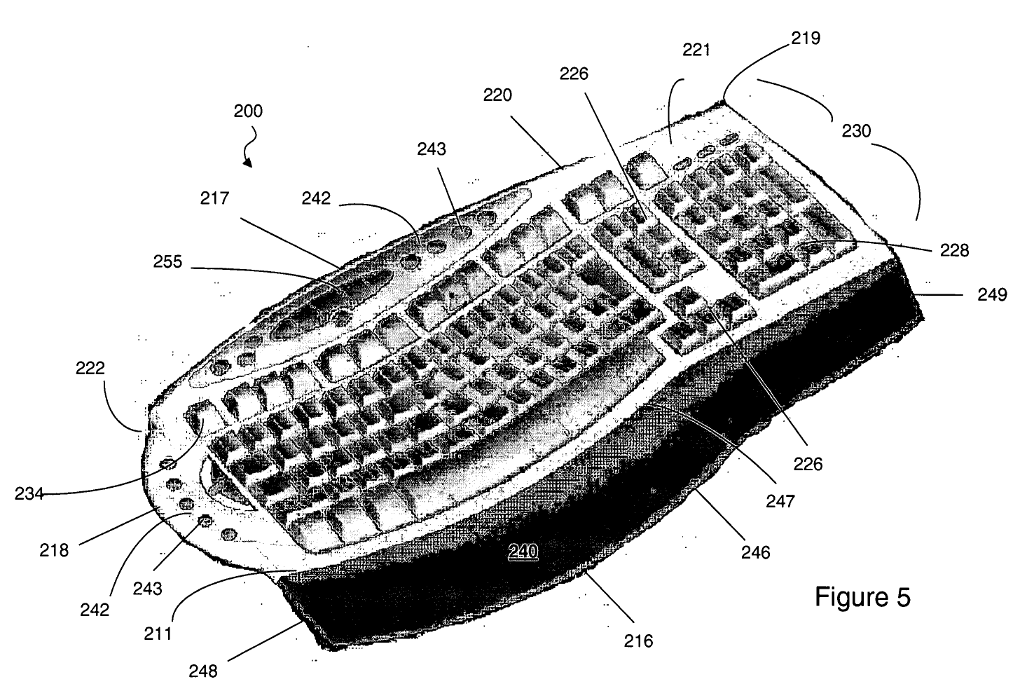

Finally, FIG. 4 illustrates a perspective view of yet another conventional non-integrated keyboard and wrist rest assembly 100D. Noticeably, the cushion is loose and removable. Similar to the assemblies in FIGS. 1-3, non-integrated keyboard and wrist rest assembly 100D has a keyboard 110D including a keyboard frame 120C, and keys 130C, cable 140C and wrist rest 160C. However, non-integrated keyboard and wrist rest assembly 100D has a non-integrated plastic wrist rest 165 upon which a user can rests his or her wrist while typing. Alternatively, pad 161 with dimensions compatible with non-integrated plastic wrist rest 165 may be placed on top of plastic wrist rest 165. Again assembly footprint 109D is significantly greater than keyboard footprint 119D or wrist rest footprint 169D.

FIGS. 1-4 are representative of conventional non-integrated keyboard and wrist rest assemblies. The keyboard and wrist rest portion of the assemblies are manufactured separately and often sold separately. One manufacturer typically produces each of these products (i.e. one makes the keyboard and one makes the wrist rest). As is apparent by the assemblies described in FIGS. 1-4, these conventional non-integrated assemblies are problematic for a number of reasons.

For example, the pitch of the surface of the keyboard is often inconsistent with the pitch of the surface. Specifically, the keyboard typing surface is at a first angle relative to the surface the keyboard and wrist rest sit on. The wrist rest, which was manufactured independently, has a top resting surface with second angle relative to the same surface that is perceptively different. The wrist rest, having a perceptively different orientation angle, typically reduces many of the specific positive ergonomic effects that may have been designed into the keyboard.

Also for example, a seam typically divides the key board and wrist rest providing an obstacle for smooth movement of a user's hands over the keyboard and wrist rest while typing. Non-integrated wrist rests add considerable area to the keyboard footprint and preclude use and operation in certain work environments including use of keyboards on work trays, keyboard holders, and supports that typically will permit keyboards to be positioned at a desirable height for reducing stress on a user's wrist. Because of the increased footprint resulting from addition of a non-integrated wrist rest, the user is forced to choose between use of a wrist rest versus a keyboard support, whereas an integrated keyboard wrist rest provides use of both.

Even when the keyboard and wrist rest are merely built separately and attached at some point prior to sale, they are currently not integrated but rather merely two block element connected physically. They still exhibit independent characteristics that may be compatible but fall short of full integration that is preferable to a user. Only a fully integrated keyboard wrist rest allows for the combination of comfort, ergonomic design, and customization that a fully integrated keyboard wrist rest can provide.

In contrast to the non-integrated wrist rests depicted in FIGS. 1-4, FIG. 5 illustrates a perspective view of an exemplary embodiment of a keyboard having an integrated gel keyboard wrist rest. Keyboard 200, as depicted, includes a keyboard housing 220, keyboard region 230 and an integrated gel palm rest 240. Keyboard region 230 includes keys and other user input structures described in more detail later. Integrated gel wrist rest 240 provides a support structure for a user's hands and wrists so as to facilitate comfortable user input to keyboard 220 in general, typically to keyboard region 230. Integrated gel wrist rest 240 is described in more detail later.

For reference purposes, the keyboard 200 has a front edge 216 adjacent the user during normal use, and a back edge 217 distal from the user during normal use. Accordingly, an object is said herein to be “behind” another object when it is between that object and the back edge 217. An object is said herein to be “directly behind” another object when it is between that object and the back edge 217 and at least partially located within the lateral bounds of that object extending in the front-to-back direction. An object is said herein to be “entirely directly behind” another object when it is between that object and the back edge 217 and entirely located within the lateral bounds of that object extending in the front-to-back direction. An object is said herein to be “in front of” another object when it is between that object and the front edge 16. Further, the keyboard 220 also has left and right edges 218 and 219. The direction “lateral” defines the general directions from the left edge 218 to the right edge 219 and from the right edge 219 to the left edge 218. Additionally, keyboard 220 has opposing faces, a top surface 221 which generally has keys attached to it and acts as a user input surface and a base 222 used for support, balance or housing of components. Additionally, for reference purposes, integrated gel wrist rest 240 may referred to as having a front edge 246, a back edge 247 and left and right edges 248 and 249. A user typically rests her hands and, wrists and palms on a top surface 244 of integrated gel wrist rest 240.

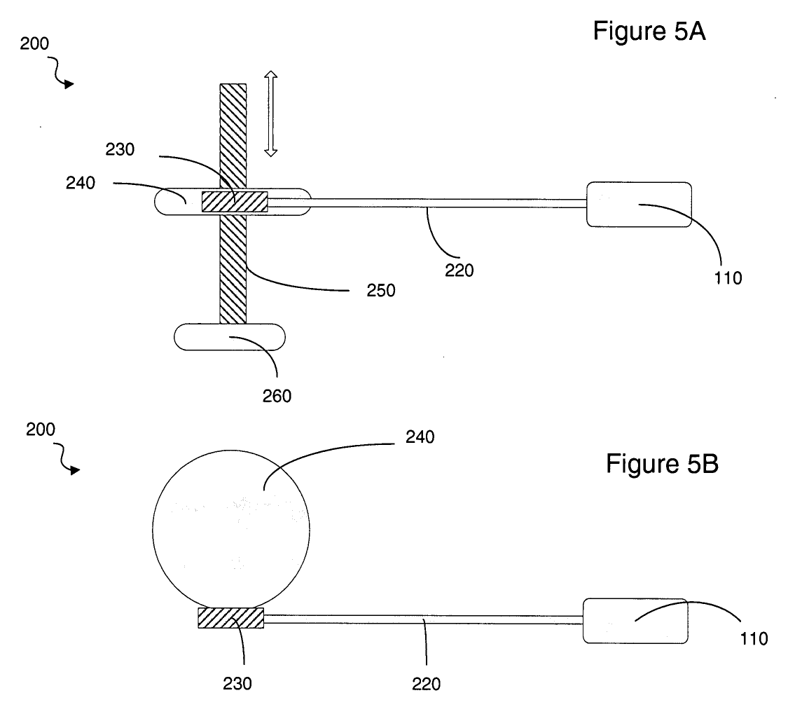

In a preferred embodiment, the keyboard 200 includes an alphanumeric section 224, an editing section 226, a numeric section 228, and a function section 229. The alphanumeric section 224, sometimes referred to as the QWERTY section, may include keys for each of the letters of the alphabet, each of the digits 0-9, and various punctuation symbols. The alphanumeric section 224 may alternatively be a subset of these keys. In this embodiment, the editing section 226, is located immediately to the right of the alphanumeric section 224, and may include four arrow keys, Delete, Home, End, PageUp, and PageDown keys. The numeric section 228 is located to the right of the editing section 226. The numeric section 228 includes at least digit keys 0-9, arithmetic function keys /, *, −, and +, a decimal separator key, and an Enter key. The function section 229 includes an Escape (or Esc) key 234 and one or more groups 238 of keys behind the alphanumeric section 224, one or more groups 236 of keys behind the numeric section 228, and one or more groups 232 of keys behind the editing section 226. These keys preferably form a laterally extending row. The keys in this row may be standard function keys and/or may be command keys preferably labeled according to the command they perform when pressed. The keys need not be limited to the key as labeled. Additionally, the keyboard 200 may include a laterally extending row of “launch” or additional command keys 239 located behind the row of keys in the function section 229. The keyboard 220 depicted also has two input zones 242, both include input keys 243 and one of the input zones 242 includes a scroll wheel 255. By “wheel” as used in this context, it is meant a rotateable device that rotates about a single axis. In the illustrated embodiment, scroll wheel 255 is mounted for rotation about an axis extending laterally relative to the keyboard 220. While the embodiment of FIG. 5 depicts a natural non-split style keyboard, conventional keyboards, split keyboards, keyboards that have an alphanumeric section 224 that may be raised, and other ergonomic keyboard designs, may also be utilized.

Keyboard 200 is typically formed of plastic and serves as a structural support and container for features such as the keypad regions, and electrical, sensing and related components (not depicted) for use in accepting user input and contained by keyboard 220. Numerous housings may be utilized including various ergonomic and “natural” style keyboards. The housing in certain embodiments may have a number of contours and curves to provide desired support to a user's hands as well as to provide comfort and alleviate repetitive stresses placed on a user's hands, wrists and fingers while typing, one of the more common of which is “Carpal Tunnel Syndrome.”

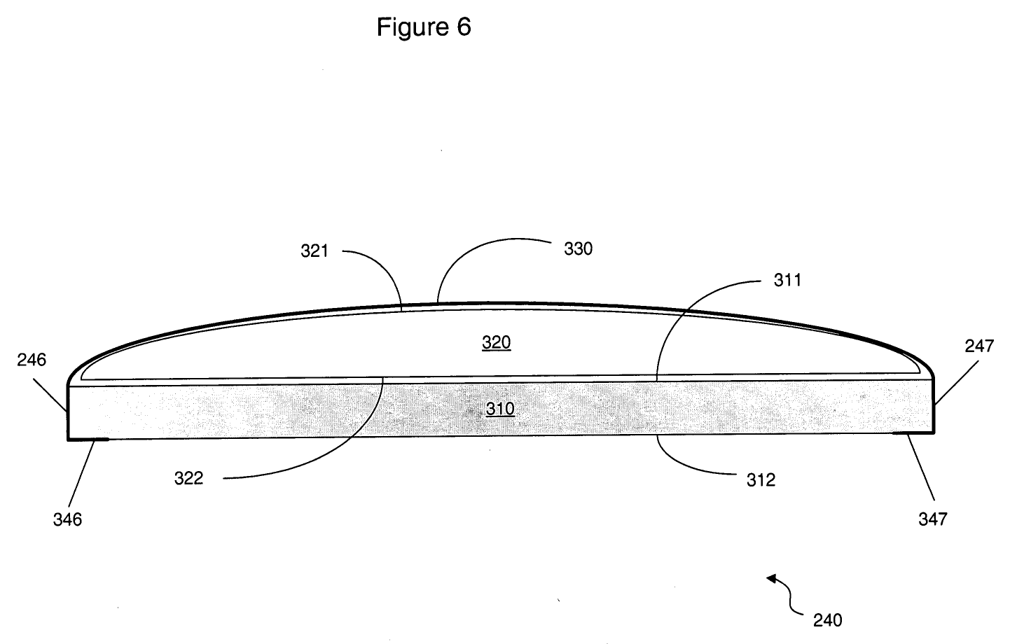

FIG. 6 illustrates a side view of a schematic of a gel wrist rest for integration into a keyboard. When fully constructed gel wrist rest 240 may to the user as a solid member. In one embodiment, wrist rest 240 includes a base member 310, a gel element 320, and a cover 330. Base member 310 may be formed to have various general shapes and specific geometries so as to be smoothly integrated into keyboard 200, specifically keyboard housing 220. For example, base member may be rectangular, s-shaped and numerous other shapes to fit the contour of a keyboard for ergonomic purposes. Base member 310 may be any suitable plastic. In one embodiment, base member 310 is composed of Acryloniprile Butadiene Styrene (ABS). Cover 330 is a generally thin layer of material, for example a sheet-like element, and may be composed of any of suitable plastics or fabrics. In one embodiment, cover 330 is a urethane fabric.

Gel element 320 may be any number of common gel materials utilized today in gel wrist rests. Many different gels can be used including stable elastomeric polymer gels, water-based gels and any other suitable gels. For example, in one embodiment gel element 320 may include stable elastomeric block polymers including gels having polymer-oil combinations. Additionally, gel element 320 may be formed of material capable of adhering to other materials. For example, in FIG. 6 gel element 320 may have characteristics and may be formed by a certain procedure that when cover 330 is placed on base 310, tops surface 321 and cover 330 physically stick, thereby providing a further securing mechanism by which gel element 320 secured to cover 330, base member 310 and keyboard housing 220.

Gel element 320 is typically formed by casting. Two general casting procedures may be used, however numerous variation exist to the specifics of the casting methods to accomplish desired specific characteristics. One exemplary casting process involves pouring heated material into a mold, in which material eventually forming cover 330 has previously been placed. The materials are physically formed in the mold, and then cool. The cover 330 and gel element 320 are then placed on base member 310 and affixed by wrapping front and back ends 346 and 347 of cover 330 around to bottom surface 312 of base member 310. These ends may be affixed to bottom surface 312 using glues and other adhesives. In a certain embodiment base member 310 may act as the mold and the gel element may be cast using base member 310 as the mold. A second exemplary casting method involves laying a fabric or other material forming cover 330, generally adhering cover 330 to base member, and then injecting material between cover 330 and base member 310, specifically on top surface 311 of base member 310. Sufficient material is injected between cover 330 and base member 310 and cooled so as to form gel element 320 and provide desired shape and feel characteristics.

Gel material is typically among the most desirable materials for its ability to cushion without significant deformation when force is applied to it. Gel is a preferred material for the described wrist rests due to certain of its characteristics including the fact it is highly resistant to bacteria and bodily fluids and can be easily cleaned with warm soapy water or a disinfectant. Further, gel is known to be a visco-elastic solid exhibiting spring qualities and dampening qualities. For example, if one depresses a gel, upon removal of the applied force the gel exhibits a fairly rapid recovery time. Gel material typically does not creep, evaporate, harden, or dry out. Also, if a wrist rest is accidentally punctured gel material does not leak. From a support perspective, gel is also preferable as. it does not collapse to the extent other cushioning materials such as foam. However, because of the complexity of the production process etc., gel is more difficult to work with from a production and manufacturing perspective when compared with foam and other cushioning materials. The later described production process overcomes some of these difficulties to provide an integrated gel keyboard wrist rest enhanced userability.

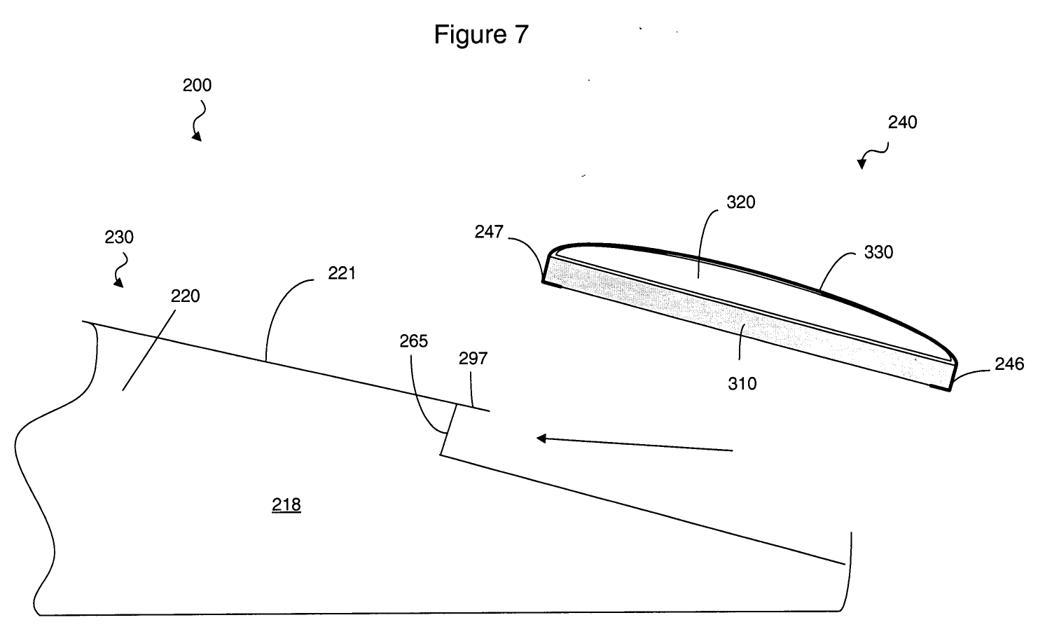

FIG. 7 illustrates a side schematic view of a gel wrist rest being affixed as part of a keyboard. Specifically, wrist rest 240, as described in FIG. 6 is shown. To form a keyboard 200 with an integrated gel wrist rest, a gel wrist rest 240 is formed with geometric dimension complimentary to portions of keyboard housing 220. For example, wrist rest 240 must be sized so that upon affixing to keyboard housing 220, a top surface 221 of keyboard 200 provides the desired angles, heights and orientations so as to provide desired ergonomic effects and comfort. For example, wrist rest 240 may be integrated such that top surface forms a substantially seamless surface with the housing surface of keypad regions 230 and top surface 330 of wrist rest 240 being co-planar. Numerous variations and offsets can be accomplished by integrating the wrist rest, rather than utilizing it as a separate member.

As shown, gel wrist rest 240 may be slid into place according to an exemplary path as shown by the illustrative arrow. Wrist rest 240 may be abutted against an interior surface 265 of keyboard housing 220. Additionally, back edge 247 is then affixed via common adhesion techniques known. In one embodiment, back edge 247 is screwed to interior surface 265. Alternatively, for example, back edge 247 may be glued, clamped or riveted to interior surface 265, to name a few. In order to form a substantially seamless boundary between keyboard housing 220 may be configured to house wrist rest 240 in a fitted fashion. For example, keyboard housing 220 may possess an overhang member 297 to abut a top surface 330. This overhang 297 helps provide a substantially seamless transition from keypad region 230 wrist rest 240.

Attachment of wrist rest 240 to keyboard housing 220, for example to interior surface 265, may be characterized as “non-removably” affixed. Here, “non-removably” means non-separable in its current state without destroying the structural integrity. For example, when a first element is attached to a second element and the second element cannot be separated without tearing or breaking etc., a portion of the first or second element or the connection between or without removing portions of the structures to access internal connectors, it may be referred to as “non-removable” consistent with the definition as used herein. Exemplary first and second elements could similarly be referred to as being “non-removably” connected.

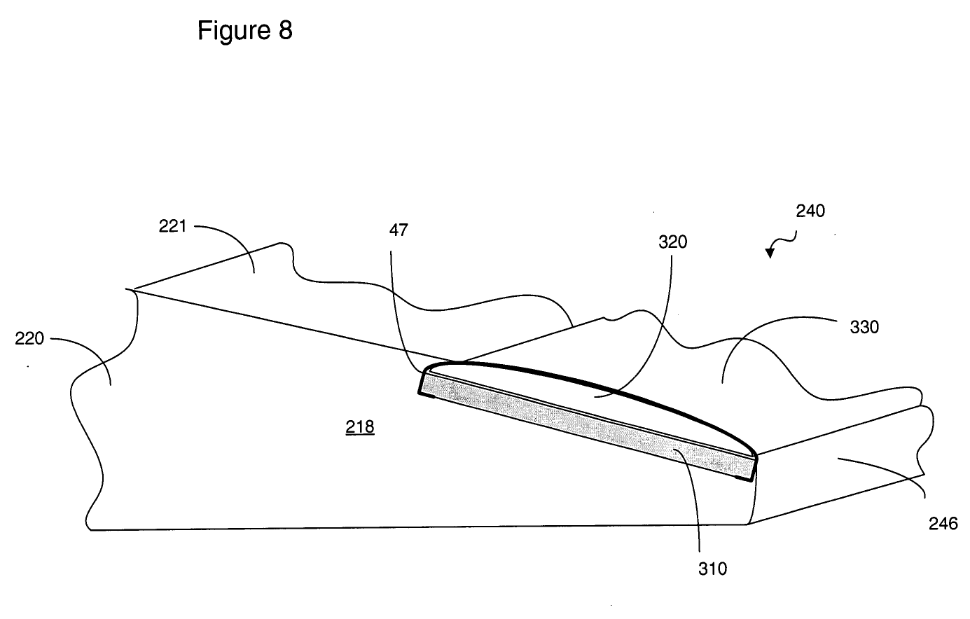

FIG. 8 illustrates a perspective view schematic of exemplary embodiment of a keyboard 200 with integrated gel wrist rest 240. A substantially seamless transition from keypad region 230 to gel wrist rest 240 is apparent in keyboard 200 is apparent. While a reveal 211 (see FIG. 5), which is a visible line which is apparent as a result of change from one material and/or texture to another, no gap or readily apparent seam that could inhibit inhibits movement or exists. Also apparent from FIG. 8 is the complete integration with the remainder of the keyboard 200, specifically keyboard housing 220. As depicted wrist rest 240 may be considered co-planar. An angle of orientation of wrist rest top surface 330 and keyboard top surface 221 are specifically the angle of palm rest surface top surface 230 and keyboard top surface 230 relative to the same bottom surface, specifically keyboard bottom surface 222. In FIG. 8, both wrist rest top surface 330 and keyboard top surface 221 have the same or substantially similar angles of orientation. The angles of orientation of each may be varied so as to accomplish desired ergonomic effects and user comfort.

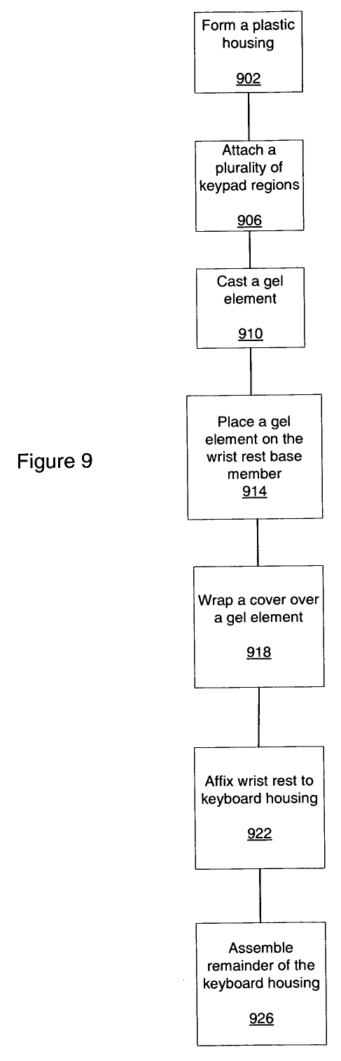

An exemplary process for producing keyboard 200 having an integrated gel wrist rest 240 is described in FIG. 9. Initially before the specific process may begin, a housing 220 design should be selected. The outer dimensions of the outermost surfaces of housing 220 should be chosen. A portion of plastic housing can be formed in step 902 utilizing plastics and related materials well known in the keyboard industry. With a housing 220 formed, user depressible keys and other portions of various keypad regions 230 are attached and formed during step 906. Among the keypad regions 230 that may be formed during this step are those previously described regarding FIG. 5, including qwerty and number keypads.

Meanwhile, step 910, one of the more involved steps in the keyboard production process, includes the casting of a gel element 320, similar to those described previously. Various specific casting procedures are typically utilized for casting wrist rests, and many of these processes are suitable to be included in this step.

In step 914, gel element 320 is placed on a wrist rest base member 310 of housing 220. The temporal component of step 914 may vary significantly from embodiment to embodiment. For example, gel element 320 may be placed on wrist rest base 310 immediately after gel element 320 has been cast. In this instance, gel element 320 may possess a substantially elevated temperature, specifically a temperature above room temperature. Alternatively, gel element 320 may be cast and allowed to cool and placed on wrist rest base 310 after gel element 320 has cooled to room temperature. Variations of the aforementioned scenarios are considered in the process as well.

Step 918 includes wrapping a cover 330 over a gel element 320 thereby securing it to wrist rest base 310. Gel element 262 may be placed on wrist rest base 310 prior to application of cover 330 or alternatively cover 330 may be entirely or partially wrapped around base 310 prior to injection of gel element 320.

Step 922 includes affixing wrist rest 240 to a portion of keyboard housing 220, as has already been described herein. After wrist rest 240 has been affixed, then the remainder of the keyboard housing is assembled or attached in step 926. Depending on the sequence of steps further steps and properties may be incorporated into the process and the order the steps are performed may be varied. While the invention has been described with respect to specific examples including tly preferred modes of carrying out the invention, those skilled in the art will iate that there are numerous variations and permutations of the above described s, techniques and processes. Thus, the spirit and scope of the invention should be rued broadly as set forth in the appended claims.

I claim:

1. A keyboard comprising:
a keyboard housing;
a keyboard region including a plurality of keys housed on a top surface of the keyboard region; and
an integrated gel wrist rest non-removably affixed to an interior surface of the keyboard housing and integrated into the keyboard housing.

2. The keyboard of claim 1, wherein the gel wrist rest includes a base member, a gel element and a cover.

3. The keyboard of claim 2, wherein the cover wraps around a bottom surface the base member.

4. The keyboard of claim 3, wherein the cover is affixed to a bottom surface of the base member.

5. The keyboard of claim 2, wherein a side of the base member is affixed to the keyboard housing.

6. The keyboard of claim 1, wherein the keyboard region possesses a qwerty key configuration.

7. The keyboard of claim 1, wherein the keyboard region further includes a plurality of key input regions and at least one of the key input regions is split.

8. The keyboard of claim 7, wherein the split key input region includes an alphanumeric section.

9. The keyboard of claim 1, wherein an entire top surface of the keyboard is substantially co-planar.

10. The keyboard of claim 1, wherein keyboard includes a transmitter for wireless communication.

11. A keyboard with an integrated gel wrist rest comprising:
a keyboard housing including a top surface and a bottom surface, wherein a keyboard region, including a plurality of keys in a plurality of keypad regions, is located on the top surface of the keyboard housing; and
an integrated wrist rest member wherein the wrist rest member abuts the keyboard region across a boundary along the front surface and along an interior surface and the wrist rest element and keyboard region are fully integrated into the keyboard housing such the wrist rest is adjacent to the keyboard region and the wrist rest forms a substantially gapless transition boundary between the wrist rest and the keyboard region within the keyboard housing.

12. The keyboard with an integrated gel wrist rest of claim 11, wherein the wrist member includes a base, a gel filler, and a cover.

13. The keyboard with an integrated gel wrist rest of claim 12, wherein the cover is wrapped around a portion of the gel filler and the base so as to encase the gel filler between the cover and the base.

14. The keyboard with an integrated gel wrist rest of claim 11, further comprising a wireless transmitter for communicating with a CPU.

15. The keyboard with an integrated gel wrist rest of claim 11, wherein the wrist rest member is split.

16. The keyboard with an integrated gel wrist rest of claim 11, further comprising a plurality of integrated wrist rest members, each possessing a distinct top surface height relative to the top surface of the keyboard.

17. A keyboard including an integrated gel wrist rest made by a process comprising the steps of:
casting a gel element;
placing the gel element on a top surface of a base member,
wrapping a cover over the gel element while the gel element is placed on the base member thereby affixing the gel element to the base member so as to form a wrist rest member;
non-removably affixing the wrist rest member to an interior member of a keyboard housing; and
assembling the remainder of the keyboard housing.

18. The user input device made by the process of claim 17, wherein immediately prior to the placing step, the gel element possesses an elevated temperature.

19. The user input device made by the process of claim 17, wherein the process further comprises the step of physically adhering the cover and the gel element together.

20. The user input device made by the process of claim 17, wherein the process further comprises the step of gluing an end of the cover to a bottom surface of the base member.
